(19) United States
(12) Patent Application Publication
(10) Pub. No.: US 2021/0085130 A1
(43) Pub. Date: Mar. 25, 2021

(54) Special disposable cutting sheet device

(71) Applicant: Melanie Osterman, Lansing, MI (US)

(72) Inventor: Melanie Osterman, Lansing, MI (US)

(21) Appl. No.: 16/578,766

(22) Filed: Sep. 23, 2019

(51) Int. Cl. A47J 47/00

(52) U.S. Cl. CPC A47J 47/005

(57) ABSTRACT

A cutting sheet formed from thin material with a curb or moat around its periphery made of a paper core and spray-on food safe acrylic water repellent sheet consisting of a cutting surface and a support surface made in a rectangular configuration with a perimeter, a limiting circularly shaped curb configuration around the perimeter wherein an amount of released juices from a foodstuff are contained, a set of pleats on the perimeter to facilitate folding of the surfaces, and a set of score lines to guide a person cutting the foodstuff wherein the person can place the foodstuff on the disposable cutting sheet device and cut the foodstuff with the score lines as guides, then the person can use the pleats to guide folding the disposable cutting sheet design into a funnel, and then the person can then dispose of the disposable cutting sheet after a one-time use.

### CROSS-REFERENCE TO RELATED APPLICATIONS

This application has no claims to previous applications.

### FIELD OF INVENTION

This invention relates cutting sheets or board for use in kitchens or other food preparation areas. The device concerns, in particular, work surfaces for the food industries, such as butchers, fishmongers, restaurants, delicatessens, etc., although not excluding its application to domestic residential cutting sheets or boards. The present invention relates generally to cutting sheets and boards formed from thin material, and more particularly to a novel and improved cutting sheet having a curb or moat around its periphery to facilitate containment of juices during trimming operations.

The present invention relates generally to protective media, and, more particularly, to a cutting sheet which is disposable. This invention relates to a kitchenware item, specifically to countertop cutting sheets and boards used for supporting food while the food is being cut. The present invention pertains to the art of food preparation and more particularly to a cutting board that is disposable. The present invention relates to systems, methods and apparatus for the preparation of food and, more specifically a surface on which to cut and otherwise process ingredients with means to easily transfer them to a variety of receiving vessels without spillage. The subject invention relates to a single use disposable cutting sheet and board assembly having a number of score lines such that a portion of the cutting sheet assembly may be folded to contain potentially pathogenic juices of red meat, fish, or poultry and also to create a more rigid transportable serving tray.

### FEDERALLY SPONSORED RESEARCH

None.

### SEQUENCE LISTING OR PROGRAM

None.

### BACKGROUND-FIELD OF INVENTION AND PRIOR ART

As far as known, there are no special disposable cutting sheet device comparable to this Osterman idea and invention. It is believed that this product is unique in its design and technologies.

### Background

The continuous use of work surfaces for cutting, in the preparation of meat, fish, vegetables, etc., causes them to become worn and this leads to problems of hygiene. In fact, the surfaces of these work tops is cut by the cutting utensils and these cuts become home to unwanted bacteria, which the usual washing procedures often cannot remove. At present, the classic method adopted by operators in this sector is to buy and use ground polyethylene sheets as cutting surfaces; these can be removed and/or exchanged and then disposed of.

Conventional chopping boards suffer from a number of disadvantages. The number of materials from which they can be made is limited, mainly to wood or plastic. Metal, stone, or glass for example blunt knives quickly or score or chip. The board or sheet scores quite quickly produce a surface which can harbor bacteria and which therefore needs very thorough cleaning. Many food cutting boards are large, heavy and cumbersome, making cleaning difficult and tedious. The life span of wooden chopping boards can be quite short if put in a dishwasher since the wood can swell and distort and the glue lines can fail. Board covers, removable mats and peal able cutting surfaces have been described before to address some of the above problems, but usually suffer from the disadvantage that they do not cover both the top and sides of the board, resulting in possible contamination of the board by food stuffs.

Cutting boards are known which have smooth cutting surfaces provided with decorative and/or functional printed designs. A problem with cutting boards having smooth cutting surfaces is that they do nothing to camouflage scratches formed as cutting tools move across their cutting surfaces. Still another problem is that the continuous and smooth nature of their cutting surfaces provides a constant, noticeable drag or resistance to the movement of cutting tools across their cutting surfaces.

Management of bacteria, liquids, fats and other waste during the preparation and handling of foods is of concern in food handling areas. Typically, such areas include the kitchen, although modern lifestyles include out-of-home occasions such as social and recreational gatherings where food is prepared, transported and/or served outside of the kitchen. Foods of particular concern from the standpoint of possibility of food-borne illness are fish, fowl and ground meats; although all foods present some degree of risk. Current media articles discuss the fact that the common cutting boards used in the preparation of foods are a source of food contamination. Other commonly used food preparation surfaces, such as countertops, also present some risk. Specifically, it has been found that bacteria can become entrapped in surface imperfections of the cutting surface, resulting in a surface that is difficult, if not impossible, to clean and/or sterilize. The cutting surface thus becomes capable of transferring bacteria to other foods, which provides a favorable media for pathogens to proliferate, resulting in an increased potential for food-borne illness, particularly when contact is had with high-risk foods. In fact, some foods considered to be pathogenically low-risk, such as fresh fruits and vegetables can become contaminated, waiting for the right environment for the bacteria to proliferate.

Another issue with cutting boards is the transfer of juices from the cutting board to other surfaces in the kitchen due to the fact that the cutting board is normally not designed to capture and contain juices during the cutting operation and thereafter through final disposal. In addition to the inconvenience of having to clean the countertop or other surface(s) exposed to the juices, a possibility exists that other food items placed on such surface(s) may be cross-contaminated. Products are in the marketplace today that attempt to address issues of liquid, fat, and bacteria management during cutting and general food preparation. However, these products fall short of optimum in one way or another. Specifically, they do not absorb, are not cut resistant, and/or fail to provide an effective bacteria barrier between the food being handled and the work surface. Also, bacteria are retained which can cause contamination during subsequent use.

Wooden cutting boards are commonly used for food preparation and provide an acceptable cutting surface which does not cause dulling of knives and prevents food from slipping on the cutting surface. However, wooden cutting boards have a porous surface which may absorb various foods and fluids. These surfaces are thus difficult to disinfect. In order to provide a cutting board which is more easily disinfected, cutting boards are being made of less porous materials including plastics and stone. The surface of the plastic cutting board is more easily washed and disinfected than wooden cutting boards. However, extended use can tend to trap food particles and fluids which can allow bacterial growth. Grooves, cuts and scratches harbor bacteria and dirt and also stain and discolor the plastic boards. Therefore, it is recommended that plastic cutting boards be replaced periodically. Still, due to the expense of replacing the plastic cutting boards, they are not replaced as often as they should to provide sanitary food preparation conditions.

### PRIOR ART

As far as known, there are no special disposable cutting sheet devices or the like. A diligent novelty search was completed. The following was revealed:
A. European patent EP1036531 issued to Glofis in 2000 for Chopping Board with Removable Cutting Surface. This invention consists a support base. On at least one covered surface of said support base, there is placed a cutting surface, either single-layer or multi-layered, where the layer or layers are removable once they become worn in such a way as to renew the chopping surface.
B. Great Britain patent GB2408444 issued to Reeves in 2005 for a Chopping Board. This shows a chopping board that consists of a main body or base, and a thin, disposable chopping surface that fits closely and securely onto the top and around the sides of the base and incorporates a gully for the collection of food juices around it's outside edge.
C. U.S. Pat. No. 4,116,426 issued to Kessler in 1978 for a Cutting Board. It demonstrates a transparent cutting board formed from plastics material has an embossed cutting surface on which mat boards and the like may be supported for trimming.
D. U.S. Pat. No. 5,984,294 issued to Bogomolny in 1999 was a Cutting Board with Replaceable Cutting Surface. Portrayed here is a cutting board assembly that is made of a rigid base member and a selectively removable surface layer. Both the base member and the surface layer are composed of a material suited for food service. The base has a flat level upper surface. The selectively removable skin layer is received over the base to provide a replaceable cutting surface thereto. At least a portion of the cutting surface outer edge is free of the curb to enable the sliding transfer of food to and from the surface.
E. U.S. Pat. No. 6,164,478 issued to Cant in 2000 for Disposable Cutting Board. Here is demonstrated a disposable cutting board assembly having an inner cutting surface, a plurality of peripheral outer borders each including an exterior edge, and a plurality of corners. A plurality of peripheral score lines separate the outer borders from the inner cutting surface. The outer borders and the corners are foldable between a first position with the outer borders and the corners in a substantially horizontal position and a second position with the outer borders and the corners in a substantially vertical position. The folding of the outer borders and corners creates a transport tray having an impervious and continuous exterior wall surrounding the inner cutting surface. The disposable cutting board assembly also includes a number of partially die cut indicia disposed along one of the outer borders. The indicia may be rotated along a living hinge to convey a particular message to a user of the cutting board.
F. U.S. Pat. No. 6,422,551 by Brotz was issued in 2002 for Disposable Cutting Board. Provided and taught is a disposable cutting board is disclosed having a tough plastic upper sheet and a lower base made of papier-mache. The user is thus encouraged to dispose of the cutting board.
G. U.S. Pat. No. 6,986,931 issued to Ackerman et al. in 2006 for Disposable Cutting Sheet. This teaches a disposable cutting sheet for cutting and preparation of food items thereon comprises a first cut-resistant layer having a first surface area and including a cellulosic ply and a thermoplastic material ply, wherein the thermoplastic material ply of the first layer includes a plurality of apertures therethrough.
H. U.S. Pat. No. 7,078,088 issued to Price et al. in 2006 for a Disposable cutting sheet. Here is shown a disposable cutting sheet for processing food items thereon includes a cut-resistant layer including a thermoplastic material ply and an absorbent ply, wherein the first layer has a surface area and wherein the thermoplastic material of the first layer includes a plurality of apertures therethrough. The cutting sheet further includes a second layer including an absorbent ply selected from the group consisting of a hydrophilic material, an oleophilic material, or a composite material having hydrophilic and oleophilic properties and a barrier ply including a thermoplastic material ply.
I. U.S. Pat. No. 7,665,719 issued to Kishbaugh, et al. in 2010 for a Food preparation board. It provides a food preparation board with multiple and distinct measurement zones. The food preparation board is made of a work surface that is provided for preparation of a food item thereon, and is sized to receive at least a portion of the food item. A rest surface is located opposite the work surface.
J. U.S. Pat. No. 9,149,159 was issued to Frey in 2015 for a Flex-i-board. This is a significantly improved plastic or wood cutting-chopping board which has four legs, each dimensioned and shaped such that when board surface is impacted by a cleaver or mallet, each of the legs can depress through three stages of compression-resistance independently and each to a degree determined by the point of impact of the cleaver on the board relative to the legs.
K. U.S. Pat. No. 10,213,055 was issued to Randall in 2019 for a Thin chopping and slicing board that facilitates easy transfer of prepared ingredients. Here is demonstrated a method using thin material such as plastic to create a flat food preparation surface of suitable size. Any durable, hygienic, and easily-cleaned substance may be utilized. The sheet is adapted by inclusion of perforations to serve has handles as well as longitudinal scoring or similar features to control site of folding.

None of the prior art addresses the special disposable cutting sheet device in the simple, direct manner with fewer parts and more simple features and configurations to provide a sanitary and disposable surface for slicing and chopping foodstuffs such as shown and taught by Osterman in the special disposable cutting sheet device. Although a crowded field, no other cutting boards or sheets or the like have the same features as this Osterman design.

### SUMMARY OF THE INVENTION

This invention is a special disposable cutting sheet device. The present invention solves the above-mentioned problems by providing a simple and effective way to provide a disposable cutting sheet that is disposable and allows for a more hygienic and sanitary preparation of foodstuffs. The preferred embodiment of a special disposable cutting sheet device made of a paper core and spray-on food safe acrylic water repellent sheet consisting of a cutting surface and a support surface made in a rectangular configuration with a perimeter, a limiting circularly shaped curb configuration around the perimeter wherein an amount of released juices from a foodstuff are contained, a set of pleats on the perimeter to facilitate folding of the surfaces, and a set of score lines to guide a person cutting the foodstuff wherein the person can place the foodstuff on the disposable cutting sheet device and cut the foodstuff with the score lines as guides, then the person can use the pleats to guide folding the disposable cutting sheet design into a funnel, and then the person can then dispose of the disposable cutting sheet after a one-time use.

The newly invented special disposable cutting sheet device can be manufactured in both low volume and high volume production.

### Objects and Advantages

There are several objects and advantages of the special disposable cutting sheet device. There are currently no disposable cutting sheet or board devices that are effective at providing the objects of this invention. The various advantages and benefits are:

| Item | Advantages |
|---|---|
| 1 | Improves Health factors - 1 million people in |
| | the USA get food poisoning every year. Of |
| | those about 23,000 are hospitalized and 450 |
| | die. Much of this is connected to the |
| | mishandling of raw poultry and fish. On a |
| | wooden cutting board, the meat juices can seep |
| | into the porous surface and be trapped, and |
| | bacteria can multiply there. The same is true |
| | for a thick, reusable plastic cutting sheet; a |
| | worn and scratched surface can inhibit thorough |
| | cleaning. And on some, juices can drip off the |
| | sides and onto counter tops unnoticed. A |
| | disposable cutting sheet helps keep the juices |
| | in one place and helps prevent contamination of |
| | other kitchen surfaces. |
| 2 | Is Easy to use - Use in place of any other |
| | portable cutting surface, but throwaway after |
| | every use. |
| 3 | Is Disposable - use one time then bring the |
| | corners together to trap any juices into the |
| | center and place into a trash can. |
| 4 | Protects Countertop Stain- surface if coated |
| | could be ideal for slicing items such as beets |
| | that stain other work-surfaces. |
| 5 | Removes Odors - Wooden and plastic cutting |
| | board can retain odors. A disposable cutting |
| | surface eliminates this problem. |
| 6 | Is Biodegradable - paper is biodegradable and |
| | comes from a renewable resource. It may be |
| | possible to be made of recycled paper. The |
| | coating could be BPA free or bio-friendly. |
| 7 | Is Inexpensive to manufacture & Low |
| | manufacturing waste - should be a single |
| | stamping process on the coated or non-coated |
| | paper to produce and cost would be pennies per |
| | unit. |
| 8 | Removes mixing raw and cooked foods - This |
| | invention removes the possibility of mistaking |
| | a cutting board used for raw meat with one used |
| | for cooked meats. They would no longer appear |
| | interchangeable and cross-contamination should |
| | not happen. |
| 9 | Is for Slicing - This invention is not meant |
| | for dicing or chopping as typically the rocking |
| | action of the knife blade or the chopping of a |
| | meat cleaver will cut a gouge in a wooden or |
| | even a plastic cutting board. This item is |
| | meant to be a place to cut up or prepare raw |
| | poultry or fish for cooking, such as separating |
| | parts of a chicken with a boning knife, |
| | trimming bones from a fish, or stuffing a |
| | turkey. |
| 10 | Can use as a double thickness - A double |
| | thickness (two disposable cutting sheet s) |
| | could be used when slicing or cutting up items |
| | where leaking might happen. |
| 11 | Contains juices released by slicing food from |
| | running over the surface of the counter |
| 12 | Can be made in various sizes and shapes |
| 13 | Can fold into a funnel to transfer food to |
| | other containers |
| 14 | Can be used to cut or process any food or other |
| | material including meat, chicken, fish, soft or |
| | hard fruits and vegetables, dough, etc. |
| 15 | can be made with food contact approved |
| | materials. |
| 16 | allows safer food preparation for the consumer |
| | and the consumer's family by reducing the risk |
| | of food-borne illness. |
| 17 | has additional uses, for example, as a |
| | placemat, as counter protection for use around |
| | stove/cook top, bin/shelf protection in |
| | refrigerator, under dog or cat dish, under |
| | plants, under large serving dishes, etc. |
| 18 | is hygienic. |
| 19 | can be used on dishes and platters to prevent |
| | scratching of same by knives. |

Finally, other advantages and additional features of the present special disposable cutting sheet device will be more apparent from the accompanying drawings and from the full description of the device. For one skilled in the art of food cutting boards and sheets, it is readily understood that the features shown in the examples with this device are readily adapted to other types of food systems and devices.

### BRIEF DESCRIPTION OF THE DRAWINGS

The accompanying drawings, which are incorporated in and constitute a part of this specification, illustrate an embodiment of the special disposable cutting sheet device that is preferred. The drawings together with the summary description given above and a detailed description given below serve to explain the principles of the cutting board or sheet device. It is understood, however, that the special disposable cutting sheet device is not limited to only the precise arrangements and instrumentalities shown.

FIGS. 1A through 1D are sketches of the special disposable cutting sheet device.

FIGS. 2A though 2F are sketches of the general special disposable cutting sheet device with components and features noted.

FIGS. 3A through 3F are sketches of the peripheral curbs or gutters and the make-up of the sheet layers shown from generally a side cross-sectional view.

FIGS. 4A through 4D are more sketches of the special disposable cutting sheet device and its use.

FIGS. 5A through 5K are sketches of prior art for cutting sheets and boards.

### DESCRIPTION OF THE DRAWINGS—REFERENCE NUMERALS

The following list refers to the drawings:

TABLE B
Reference numbers

| Ref | |
|---|---|
| # | Description |
| 30 | special disposable cutting sheet device 30 |
| 31 | plan view 31 |
| 32 | side view 32 |
| 33 | end view 33 |
| 34 | cross-section view 34 |
| 34A | cross-section view curb 34A |
| 34B | cross-section view dip 34B |
| 35 | cutting surface 35 where slicing and |
| | preparation occurs to foodstuff 90 |
| 37 | support surface 37 nearest table, counter |
| | top or block |
| 38 | pleating/ fold lines 38 |
| 39 | score line 39 |
| 40 | moat, gutter, trough, dip 40 as a limiting |
| | configuration for juices from foodstuff 90 |
| 40A | curb, siding, rise 40A as a limiting |
| | configuration for juices from foodstuff 90 |
| 41 | circular, curved, semicircle configuration 41 |
| 42 | square, rectangular, box configuration 42 |
| 43 | trapezoid configuration 43 |
| 45 | short end 45 |
| 47 | long side 47 |
| 50 | perimeter, periphery, outer edge 50 of device 30 |
| 53 | square or rectangular device 53 |
| 55 | circular or round device 55 |
| 57 | oval or elliptical device 57 |
| 60 | typical pressed paper, card board, plastic or |
| | composite material 60 device 30 |
| 63 | coated particles 63 with plastic, silicon, wax, |
| | polyurethane that is cured, or food safe |
| | composite material on the particles, then |
| | pressed/ compressed/ or formed to shape of |
| | device 30 |
| 65 | coated device 65 which is pressed material |
| | board 60 then spray or dip coated with |
| | liquid impervious material 66 |
| 66 | liquid impervious, food safe material 66 such |
| | as wax, silicon, acrylic, or composite material. |
| 90 | foodstuff 90 a chicken, a turkey, a ham, a beef |
| | roast, a pork roast, a set of vegetables, and a |
| | set of fruit. |
| 100 | person or operator 100 |
| 110 | Prior Art 110 Patent - EP 1036531A1 by Andrea |
| | Polli a Chopping Board with Removable |
| | cutting surface |
| 112 | Prior Art 112 Patent - GB 2408444A by John W |
| | Reeves et al a Chopping Board |
| 114 | Prior Art 114 Patent - U.S. Pat. No. 5,984,294 by |
| | Bogomolny a Cutting Board with Replaceable |
| | Cutting Surface |
| 116 | Prior Art 116 Patent - U.S. Pat. No. 4,116,426 by |
| | Kessler a Cutting board |
| 118 | Prior Art 118 Patent - U.S. Pat. No. 6,164,478 by |
| | Cant a Disposable cutting board |
| 120 | Prior Art Patent 120 - U.S. Pat. No. 6,422,551 by |
| | Brotz a Disposable cutting board |
| 122 | Prior Art Patent 122 - U.S. Pat. No. 6,986,931 by |
| | Ackerman et al a Disposable cutting sheet |
| 124 | Prior Art Patent 124 - U.S. Pat. No. 7,665,719 by |
| | Kishbaugh a Food preparation board |
| 126 | Prior Art Patent 126 - U.S. Pat. No. 7,078,088 by |
| | Price et al a Disposable cutting sheet |
| 128 | Prior Art Patent 128 - U.S. Pat. No. 9,149,159 by |
| | Frey a Flex-i-board |
| 130 | Prior Art Patent 130 - U.S. Pat. No. 10,213,055 by |
| | Randall a Thin chopping and slicing board that |
| | facilitates easy transfer of prepared ingredients |

### DETAILED DESCRIPTION OF PERFERRED EMBODIMENT

This invention relates cutting sheet for use in kitchens or other food preparation areas. The device concerns, in particular, work surfaces for the food industries, such as butchers, fishmongers, restaurants, delicatessens, etc., although not excluding its application to domestic residential cutting sheets. The present invention relates generally to cutting boards and sheets formed from thin material, and more particularly to a novel and improved cutting sheet having a curb or moat around its periphery to facilitate containment of juices during trimming operations. The present invention relates generally to protective media, and, more particularly, to a cutting sheet which is disposable. This invention relates to a kitchenware item, specifically to countertop cutting boards used for supporting food while the food is being cut. The present invention pertains to the art of food preparation and more particularly to a cutting sheet that is disposable. The present invention relates to systems, methods and apparatus for the preparation of food and, more specifically a surface on which to cut and otherwise process ingredients with means to easily transfer them to a variety of receiving vessels without spillage. The subject invention relates to a single use disposable cutting board assembly having a number of score lines such that a portion of the cutting board assembly may be folded to contain potentially pathogenic juices of red meat, fish, or poultry and also to create a more rigid transportable serving tray.

The advantages for the special disposable cutting sheet device 30 are listed above in the introduction. Succinctly the benefits are that the device:
A. Improves Health factors—over 1 million people in the USA get food poisoning every year.
B. Is Easy to use—Use in place of any other portable cutting surface, but throwaway after every use.
C. Is Disposable—use one time then bring the corners together to trap any juices into the center and place into a trash can.
D. Protects Countertop Stain
E. Removes Odors—Wooden and plastic cutting board can retain odors.
F. Is Biodegradable—renewable resource and may be made of recycled paper.
G. Is Inexpensive to manufacture & Low manufacturing waste
H. Removes mixing raw and cooked foods
I. Is for Slicing
J. Can use as a double thickness
K. Contains juices released by slicing food
L. Can be made in various sizes and shapes
M. Can fold into a funnel to transfer food to other containers
N. Can be used to cut or process any food
O. Allows safer food preparation for the consumer and family
P. Has additional uses, for example as a placemat or counter protection
Q. Is hygienic
R. Can be used on dishes and platters to prevent scratching of same by knives

The preferred embodiment of a special disposable cutting sheet device made of a paper core and spray-on food safe acrylic water repellent sheet consisting of a cutting surface and a support surface made in a rectangular configuration with a perimeter, a limiting circularly shaped curb configuration around the perimeter wherein an amount of released juices from a foodstuff are contained, a set of pleats on the perimeter to facilitate folding of the surfaces, and a set of score lines to guide a person cutting the foodstuff wherein the person can place the foodstuff on the disposable cutting sheet device and cut the foodstuff with the score lines as guides, then the person can use the pleats to guide folding the disposable cutting sheet design into a funnel, and then the person can then dispose of the disposable cutting sheet after a one-time use.

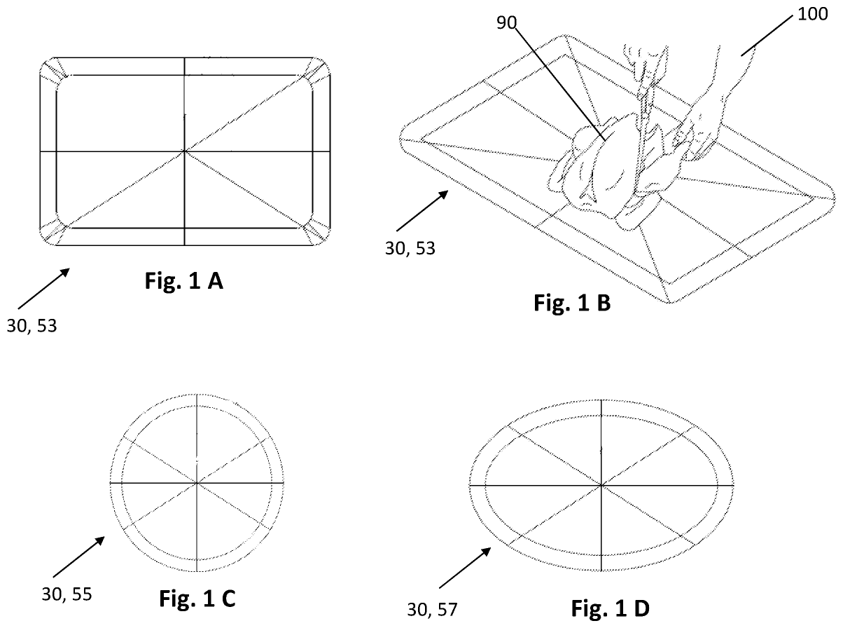

There is shown in FIGS. 1-5 a complete description and operative embodiment of the special disposable cutting sheet device 30. In the drawings and illustrations, one notes well that the FIGS. 1-5 demonstrate the general configuration and use of this product and system. The various example uses are in the operation and use section, below.

The accompanying drawings, which are incorporated in and constitute a part of this specification, illustrate an embodiment of the special disposable cutting sheet device 30 that is preferred. The drawings together with the summary description given above and a detailed description given below serve to explain the principles of the disposable cutting sheet 30. It is understood, however, that the device 30 is not limited to only the precise arrangements and instrumentalities shown. Other examples of system and devices and uses are still understood by one skilled in the art of cutting sheets, boards and chopping to be readily adapted to other types of systems and devices and still be well within the scope and spirit shown here.

FIGS. 1A through 1D are sketches of special disposable cutting sheet device 30. In these views are shown and demonstrated: a special disposable cutting sheet device 30; a square or rectangular device 53; a circular or round device 55; an oval or elliptical device 57; a foodstuff 90 a chicken, a turkey, a ham, a beef roast, a pork roast, a set of vegetables, and a set of fruit; and a person or operator 100.

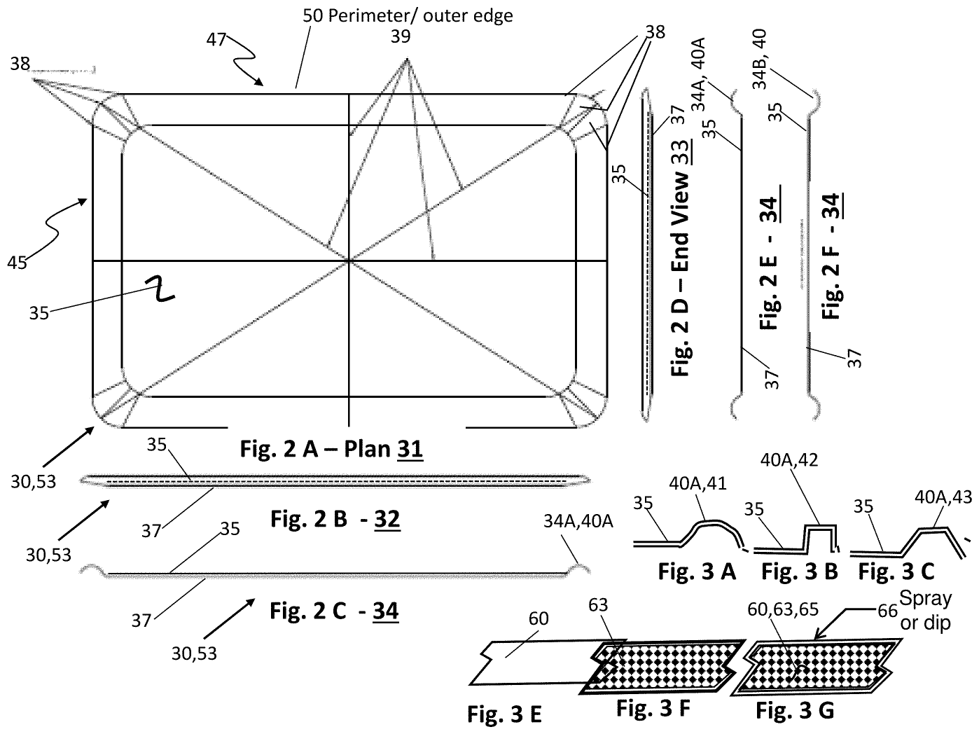

FIGS. 2A though 2F are sketches of the general special disposable cutting sheet device 30 with components and features noted. The features shown include: a special disposable cutting sheet device 30; a plan view 31; a side view 32; an end view 33; a cross-section view 34; a cross-section view curb 34A; a cross-section view of dip 34B; a cutting surface 35 where slicing and preparation occurs to foodstuff 90—a chicken, a turkey, a ham, a beef roast, a pork roast, a set of vegetables, and a set of fruit; a support surface 37 nearest table, counter top or block; a set of pleating/fold lines 38; a set of score lines 39; a moat, gutter, trough, dip 40 as a limiting configuration for juices from foodstuff 90; a curb, siding, rise 40A as a limiting configuration for juices from foodstuff 90; a short end 45; a long side 47; and a perimeter, periphery, outer edge 50 of device 30.

FIGS. 3A through 3F are sketches of the peripheral curbs 40A or gutters 40 and the make-up of the sheet layers shown from generally a side cross-sectional view. Provided in these view for a special disposable cutting sheet device 30 are: a cutting surface 35 where slicing and preparation occurs to foodstuff 90; a moat, gutter, trough, dip 40 as a limiting configuration for juices from foodstuff 90 (the reverse image of a curb, siding, rise 40A as a limiting configuration for juices from foodstuff 90); a circular, curved, semicircle configuration 41; a square, rectangular, box configuration 42; a trapezoid configuration 43; a typical pressed paper, card board, plastic or composite material 60 device 30; a coated particles 63 with plastic, silicon or wax on particles, then pressed/ compressed/or formed to shape of device 30; a coated device 65 which is pressed material board 60 then spray or dip coated with liquid impervious material 66; and a liquid impervious, water repellant or resistant food safe material 66 such as wax, silicon, acrylic or composite material. A high performance polymers may be used across a wide variety of applications in the food industry and offer many beneficial characteristics including: excellent resistance to chemicals such as boiling water, fats, oils, acids, alkalis and many solvents, capable of withstanding extreme temperature conditions, resists steam, radiation and frozen storage conditions, contains no solvents or diluents, and has convenient handling. Food Grade Silicone Sealant is a non-slump sealant. A Polyurethane varnish does not present any known hazard and is food safe once it is fully cured. I have an idea for a new product. It's a paper one-time use cutting sheet. The surface would need to be made of thin cardboard about 1 mm thick and coated like a paper plate but about approximately 11 inches by 17 inches. Various sizes and configurations (round, rectangular, oval, elliptical are anticipated but are offered as examples and not as limitations.

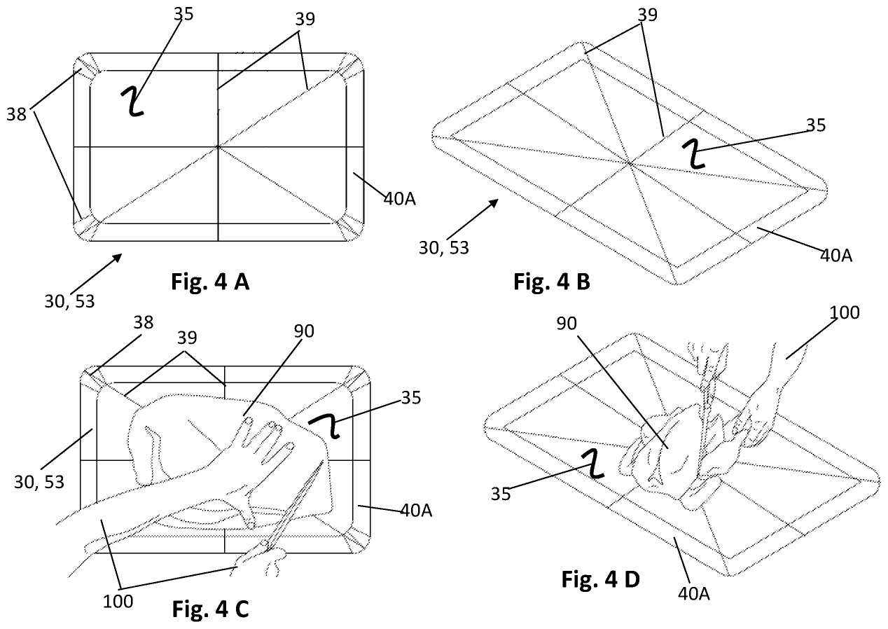

FIGS. 4A through 4D are more sketches of the special disposable cutting sheet device 30 and its use. These are described below in the Operation section.

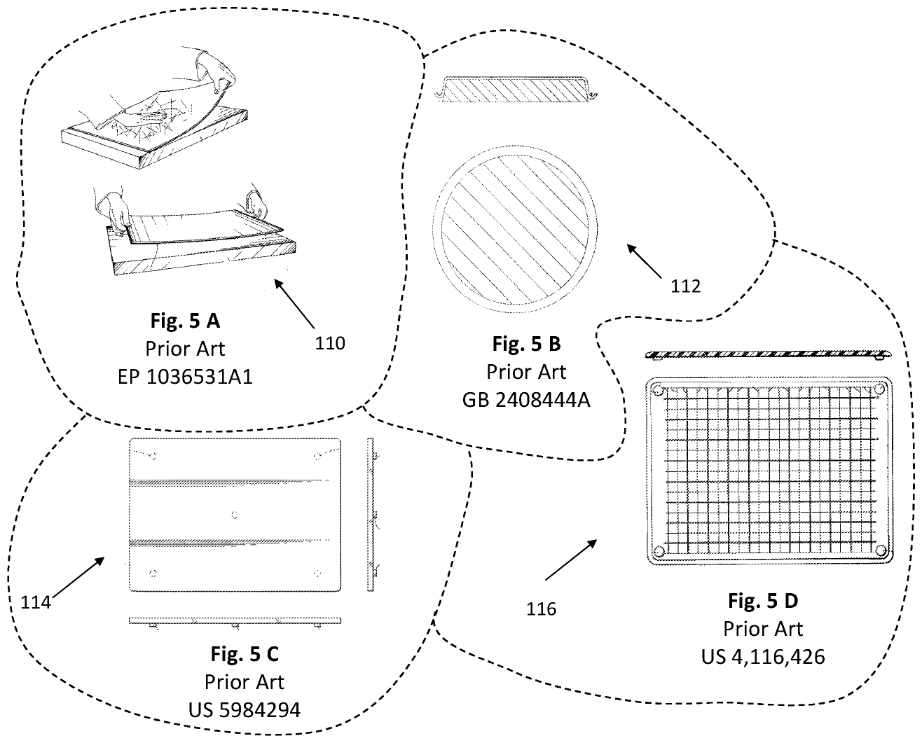

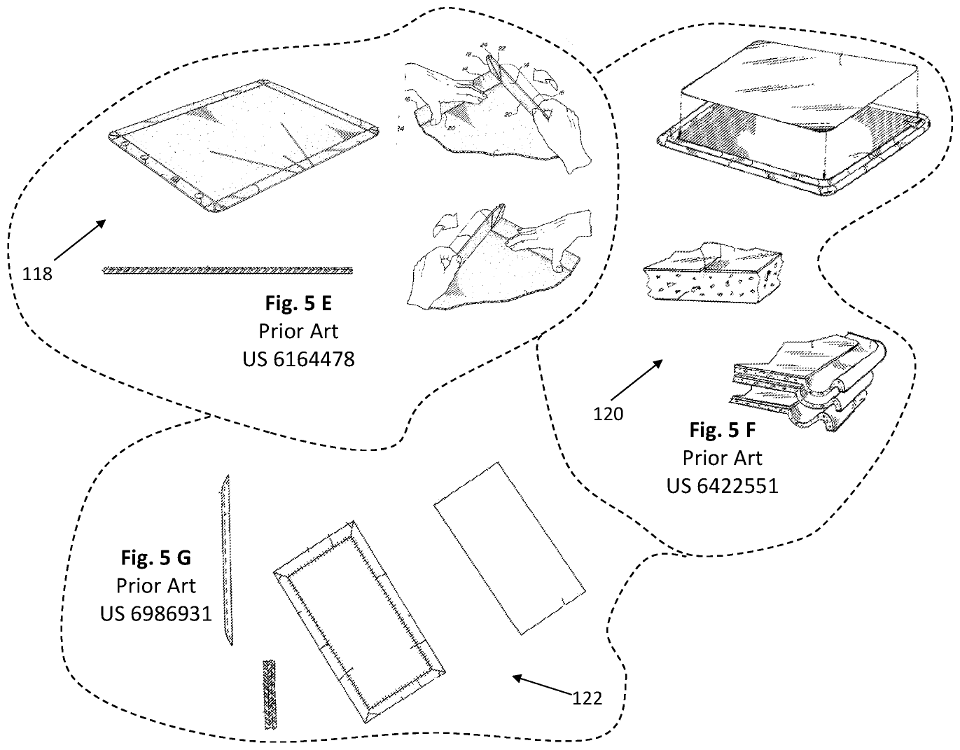

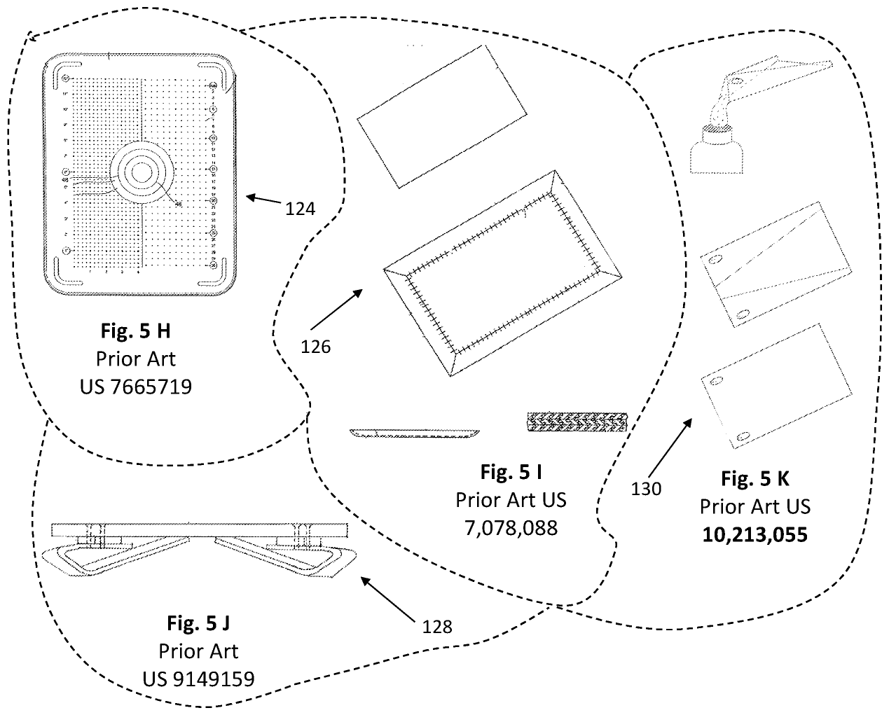

FIGS. 5A through 5K are sketches of prior art for cutting sheets and boards. In these figures are shown: Prior Art 110 Patent—EP 1036531A1 by Andrea Polli a Chopping Board with Removable cutting surface; Prior Art 112 Patent—GB 2408444A by John W Reeves et al a Chopping Board; Prior Art 114 Patent—U.S. Pat. No. 5,984,294 by Bogomolny a Cutting Board with Replaceable Cutting Surface; Prior Art 116 Patent—U.S. Pat. No. 4,116,426 by Kessler a Cutting board; Prior Art 118 Patent—U.S. Pat. No. 6,164,478 by Cant a Disposable cutting board; Prior Art Patent 120—U.S. Pat. No. 6,422,551 by Brotz a Disposable cutting board; Prior Art Patent 122—U.S. Pat. No. 6,986,931 by Ackerman et al a Disposable cutting sheet; Prior Art Patent 124—U.S. Pat. No. 7,665,719 by Kishbaugh a Food preparation board; Prior Art Patent 126—U.S. Pat. No. 7,078,088 by Price et al a Disposable cutting sheet; Prior Art Patent 128—U.S. Pat. No. 9,149,159 by Frey a Flex-i-board; Prior Art Patent 130—U.S. Ser. No. 10,213,055 by Randall a Thin chopping and slicing board that facilitates easy transfer of prepared ingredients.

The details mentioned here are exemplary and not limiting. Other specific components and manners specific to describing a special disposable cutting sheet device 30 may be added as a person, having ordinary skill in the field of cutting board, sheets and chopping blocks well appreciates.

### OPERATION OF THE PREFERRED EMBODIMENT

The special disposable cutting sheet device 30 has been described in the above embodiment. The manner of how the device operates is described below. One notes well that the description above and the operation described here must be taken together to fully illustrate the concept of the special disposable cutting sheet device 30. The preferred embodiment of a special disposable cutting sheet device made of a paper core and spray-on food safe acrylic water repellent sheet consisting of a cutting surface and a support surface made in a rectangular configuration with a perimeter, a limiting circularly shaped curb configuration around the perimeter wherein an amount of released juices from a foodstuff are contained, a set of pleats on the perimeter to facilitate folding of the surfaces, and a set of score lines to guide a person cutting the foodstuff wherein the person can place the foodstuff on the disposable cutting sheet device and cut the foodstuff with the score lines as guides, then the person can use the pleats to guide folding the disposable cutting sheet design into a funnel, and then the person can then dispose of the disposable cutting sheet after a one-time use.

The special disposable cutting sheet device 30 operates as described in the following FIGS. 4A through 4D that show its use. Shown here are the following: a special disposable cutting sheet device 30; a cutting surface 35 where slicing and preparation occurs to foodstuff 90; a set of pleating/fold lines 38; a set of score lines 39; a curb, siding, rise 40A as a limiting configuration for juices from foodstuff 90; a square or rectangular device 53; a foodstuff 90 chicken, turkey, ham, beef roast, pork, vegetables and fruits; and a person or operator 100. Operation is simple. An operator 100 get a special disposable cutting sheet device 30 and places it on a support surface 37 table, counter, etc. Then the operator 100 gets a foodstuff 90 (chicken, turkey, ham, beef roast, pork, vegetables and fruits) and a knife to cut the foodstuff 90. The curb 40A or gutter 40 as a limiting configuration for juices from foodstuff 90. When ready to transfer, the special disposable cutting sheet device 30 can be folded along the score lines 39 or the pleat lines 38 to fold the cutting sheet device 30 to create a funnel and transfer the foodstuffs 90 to another pan or plate. When done, the cutting sheet device 30 may be placed into a trash can for easy disposal.

With this description it is to be understood that the special disposable cutting sheet device 30 and other optional embodiments are not to be limited to only the disclosed embodiment of product. The features of the special disposable cutting sheet device 30 and other embodiments are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

1. An one-piece disposable cutting sheet device made of water resistant sheet comprising:
a. a cutting surface and a support surface made in a rectangular configuration with a perimeter;
b. a preformed curved curb around the perimeter of the one-piece disposable cutting sheet device wherein the gutter is pre-formed without need of additional manipulation along each of two short ends, each of two long ends, and at each of the four joining corners where the short and long ends meet and wherein an amount of released juices from a foodstuff are contained;
c. a set of pleats on the perimeter to facilitate folding of the surfaces; and
d. a set of score lines to guide a person cutting the food stuff wherein the person can place the foodstuff on the disposable cutting sheet device and cut the foodstuff with the score lines as guides; then the person can use the pleats to guide folding the disposable cutting sheet design into a funnel; and wherein the person can then dispose of the disposable cutting sheet after a one-time use.

2.-5. (canceled)

6. The special disposable cutting sheet device according to claim 1 wherein the gutter is selected from a group of configurations consisting of a curve, a square and a trapezoid shape.

7. The special disposable cutting sheet device according to claim 1 wherein the food stuff is selected from a group consisting of a chicken, a turkey, a ham, a beef roast, a pork roast, a set of vegetables, and a set of fruit.

8. The special disposable cutting sheet device according to claim 1 wherein the water resistant sheet is selected from a group consisting of pressed paper, card board, plastic and composite material.

9. The special disposable cutting sheet device according to claim 1 wherein the water resistant sheet is a pressed paper that is coated with a liquid impervious material.

10. The special disposable cutting sheet device according to claim 9 wherein the impervious material is selected from a group consisting of wax, silicon, acrylic, and composite material.

11. The special disposable cutting sheet device according to claim 1 wherein the water resistant sheet is made of particles with a coating, wherein the particles are compressed into a sheet.

12. The special disposable cutting sheet device according to claim 11 wherein the coating is selected from a group consisting of plastic, silicon, wax, polyurethane that is cured and is a food safe composite material.

13.-18. (canceled)
